(19) United States
(12) Patent Application Publication
(10) Pub. No.: US 2020/0111445 A1
(43) Pub. Date: Apr. 9, 2020

(54) ENVIROMENTALLY CONTEXTUAL HUD WITH GRAPHICAL AUGMENTATION THROUGH VEHICLE CAMERA PROCESSING SYSTEM

(71) Applicant: Panasonic Automotive Systems Company of America, Division of Panasonic Corporation of North America, Peachtree City, GA (US)

(72) Inventors: ANDREW BIANCHI, ROYAL OAK, MI (US); SACHIKO KOBAYASHI, NOVI, MI (US)

(73) Assignee: Panasonic Automotive Systems Company of America, Division of Panasonic Corporation of North America

(21) Appl. No.: 16/589,465

(22) Filed: Oct. 1, 2019

Related U.S. Application Data
(60) Provisional application No. 62/740,461, filed on Oct. 3, 2018.

(51) Int. Cl. G09G 5/02; G02B 27/01; B60R 1/00; B60K 35/00

(52) U.S. Cl. CPC G09G 5/026; B60R 2300/80; B60R 1/00; B60K 35/00; G09G 2380/10; G09G 2340/12; G09G 2320/0666; G09G 2320/066; G09G 2360/144; G02B 2027/0118; G02B 2027/0112; B60R 2300/205; B60K 2370/1529; B60K 2370/176; B60K 2370/177; B60K 2370/188; B60K 2370/23; B60K 2370/21; B60K 2370/48; B60K 2370/785; G02B 27/0101

(57) ABSTRACT

A head up display arrangement is fix a motor vehicle having a human driver. A light source emits a light field including a first color such that the light field is visible to the driver as a virtual image. A light sensor detects a second color that is visible to the driver in a forward direction of the vehicle in an ambient environment outside of the vehicle. An electronic processor is communicatively coupled to both the light source and the light sensor. The processor changes the first color in the light field to a third color. The third color is dependent upon the second color.

### CROSS-REFERENCED TO RELATED APPLICATIONS

This application claims benefit of U.S. Provisional Application No. 62/740,461 filed on Oct. 3, 2018, the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

In a head up display, graphics are projected onto a transparent glass surface. Because there is not an opaque surface such as that in a traditional thin-film-transistor (TFT) liquid-crystal display (LCD), there is an absence of black when driving graphics. This absence of black or opaqueness creates obstacles for ensuring adequate contrast, especially color contrast. Current Head up display systems project/display graphics onto glass with no way of understanding what the background environment colors are beyond/behind the glass surface (e.g., the area in front of the car). Additionally, the measure of color contrast is calculated by determining differences in color value of two (or more) referenced objects. As an example, the color contrast of this text is calculated by understanding the color value assigned to this text and the color value assigned to the background it sits on (the paper's white color) and then measuring the difference between the two color values of the mentioned objects. To optimize color contrast, the values of each of the elements in the total composition must be understood. In the case of the current head up display systems, the color values assigned to graphical elements being rendered can be understood, but the background environment has no calculable value. Therefore, creating visible graphics is not as easy as with a traditional TFT LCD because we cannot appropriately measure the color value of the environment in which the rendered graphics appear to overlay. Today's solutions make use of brightness sensors to be able to determine the appropriate brightness level of graphics.

Current systems have no way of determining what color environment is beyond the displayed graphics, therefore there are limitations to the amount of visual color contrast that can be created. Today's solutions are very limited and mostly cater to day/night modes by adjusting the brightness.

As more content, and even camera feeds, are being displayed on HUDs, there are more obstacles in creating highly visible, high contrast images as it is not possible to control the environmental factors outside the car. As more features are added to HUDs, it will be important to make sure the added features are visible in all situations and under all conditions.

### SUMMARY

The present invention may provide a method for creating an automatic, contextually-configured human-machine interface (HMI) for a Head Up Display (HUD) in a motor vehicle. The HUD may be contextually driven by the surrounding environment and/or terrain. Utilizing a combination of image sensors (e.g., image sensors on the outside of the vehicle), the captured images and information may be used to determine What the colors of the surrounding environment are. Based on the information gained by these sensors, the HUD graphics may be re-rendered by applying a new color and/or adjusting the placement position to create highly visible graphics within the context of that specific environment background. Thus, the invention may ultimately provide virtual images with greater color contrast with the background against which the virtual images are presented.

In one embodiment, if the vehicle is driving toward a sunset, the vehicle camera sensors may detect the light intensity, color and detail of the ambient environment in the forward-facing direction. Within these image feeds, the HUD may use color detection technology to detect, for example, the presence of bright yellows, oranges and hues of reds. The HUD may then compare that color data to the colors presented in the current HUD graphics (e.g., the virtual image). If the current graphics colors are close in family to the colors of the sunset background (e.g., based on color theory studies) the HUD may augment those graphics by applying a new color code that is in the family of complementary colors (e.g., according to the color theory sciences) to create graphics images with greater contrast vis-a-vis the background scene. In this sunset background example, the graphics may get treatments of blues and greens based on the science of color theory and complementary color principles.

The present invention improves not just brightness, but also modifies colors of the displayed images depending upon a variety of environmental factors. Ultimately, color contrast is controlled, which is not possible by use of brightness sensors alone.

In one embodiment, the invention comprises a head up display arrangement for a motor vehicle having a human driver. A light source emits a light field including a first color such that the light field is visible to the driver as a virtual image. A light sensor detects a second color that is visible to the driver in a forward direction of the vehicle in an ambient environment outside of the vehicle. An electronic processor is communicatively coupled to both the light source and the light sensor. The processor changes the first color in the light field to a third color. The third color is dependent upon the second color.

In another embodiment, the invention comprises a head up display method for a motor vehicle having a human driver. A light field including a first color is emitted such that the light field is visible to the driver as a virtual image. A second color that is visible in a forward direction of the vehicle in an ambient environment outside of the vehicle is detected. The first color in the light field is changed to a third color. The third color is dependent upon the second color.

In yet another embodiment, the invention comprises a head up display arrangement for a motor vehicle having a human driver. A light source emits a light field including a first color such that the light field is reflected off of a windshield of the vehicle and the light field is visible to the human driver as a virtual image. A light sensor detects a second color that is visible in a background of the virtual image as viewed by the human driver. An electronic processor is communicatively coupled to both the light source and the light sensor. The processor compares the first color to the second color. If the color comparison reveals that a contrast between the first color and the second color is less than a threshold, then the first color in the light field is changed to a third color such that a contrast between the third color and the second color is greater than the contrast between the first color and the second color.

An advantage of the present invention is that by using intelligent data processing, the exact color(s) and content in the background behind the displayed graphics may be determined so that augmented graphics may be better displayed.

Another advantage of the present invention is that it may provide graphics that are more visible graphics in specific situations wherein the graphics of current head up displays are not easily visible.

Yet another advantage of the present invention is that it may provide the ability to augment graphics in a variety of ways to achieve better visibility in all environmental states and with all background colors.

### BRIEF DESCRIPTION OF THE DRAWINGS

A better understanding of the present invention will be had upon reference to the following description in conjunction with the accompanying drawings.

FIG. 1a is a rear overhead view of one embodiment of a motor vehicle including an environmentally contextual HUD arrangement of the present invention.

FIG. 1b is a plan view of a sample of colors of the forward-facing environment of the vehicle of FIG. 1a as captured by a camera of the environmentally contextual HUD arrangement of the vehicle of FIG. 1a.

FIG. 1c is a plan view out of a windshield of the vehicle of FIG. 1a of a virtual image of a HUD with the forward-facing environment in the background.

FIG. 1d is a side by side comparison of the sample of colors of FIG. 1b and the virtual image of FIG. 1c.

FIG. 1e is a plan view out of a windshield of the vehicle of FIG. 1a of a virtual image of a HUD after the colors of the virtual image have been adjusted according to the present invention, and with the forward-facing environment in the background.

FIG. 2a is a rear overhead view of another embodiment of a motor vehicle including an environmentally contextual HUD arrangement of the present invention.

FIG. 2b is a plan view of a sample of colors of the forward-facing environment of the vehicle of FIG. 2a as captured by a camera of the environmentally contextual arrangement of the vehicle of FIG. 2a.

FIG. 2c is a plan view out of a windshield of the vehicle of FIG. 2a of a virtual image of a HAD with the forward-facing environment in the background.

FIG. 2d is a side by side comparison of the sample of colors of FIG. 2b and the virtual image of FIG. 2c.

FIG. 2e is a plan view out of a windshield of the vehicle of FIG. 2a of a virtual image of a HUD after the colors of the virtual image have been adjusted according to the present invention, and with the forward-facing environment in the background.

FIG. 3a is a rear overhead view of yet another embodiment of a motor vehicle including an environmentally contextual HUD arrangement of the present invention.

FIG. 3b is a plan view of a sample of colors of the forward-facing environment of the vehicle of FIG. 3a as captured by a camera of the environmentally contextual HUD arrangement of the vehicle of FIG. 3a.

FIG. 3c is a plan view out of a windshield of the vehicle of FIG. 3a of a virtual image of a HUD with the forward-facing environment in the background.

FIG. 3d is a side by side comparison of the sample of colors of FIG. 3b and the virtual image of FIG. 3c.

FIG. 3e is a plan view out of a windshield of the vehicle of FIG. 3a of a virtual image of a HUD after the colors of the virtual image have been adjusted according to the present invention, and with the forward-facing environment in the background.

FIG. 4 is a block diagram of one embodiment of a head up display arrangement of the present invention for a motor vehicle with a human driver.

FIG. 5 is a flow chart of one embodiment of a head up display method of the present invention for a motor vehicle having a human driver.

### DETAILED DESCRIPTION OF THE PREFERRED EMBODIMENTS

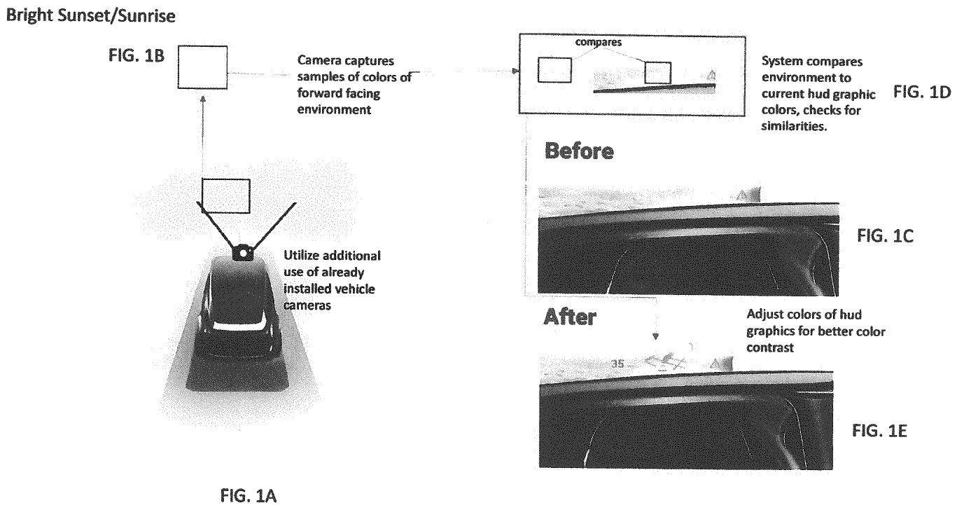

FIG. 1a illustrates one embodiment of a motor vehicle including an environmentally contextual HUD arrangement of the present invention. The HUD arrangement includes a forward-facing camera that captures images of the scene in front of the vehicle that may be in the background of the virtual images provided by the HUD. The camera may be used liar other purposes, such as capturing images of other vehicles and pedestrians on the road, for example.

FIG. 1b illustrates a sample of colors of the forward-facing environment of the vehicle of FIG. 1a as captured by a camera of the environmentally contextual HUD arrangement of the vehicle of FIG. 1a. In this example, the sample includes shades of yellow and orange, which may be due to the vehicle driving toward a bright sunrise or sunset.

FIG. 1c illustrates a view out of a windshield of the vehicle of FIG. 1a of a virtual image of a HUD with the forward-facing environment in the background. In this example, the virtual image includes a lot of yellow, and the view through the windshield includes shades of yellow and orange, which may be due to the vehicle driving toward a bright sunrise or sunset.

FIG. 1d illustrates a side by side comparison of the sample of colors of FIG. 1b and the virtual image of FIG. 1c. The HUD arrangement may include an electronic processor which compares the environmental background colors to the current HUD virtual image graphics colors. The processor may check for similarities between the environmental background colors and the current HUD virtual image graphics colors. In this case, the processor may determine, by applying principles of color science and/or by using a lookup table, that the yellow colors in the HUD virtual image graphics colors are very close to the shades of yellow and orange in the background. For example, the processor may determine that the colors are too close for the human driver to easily discern the HUD virtual image and see what the HUD is presenting.

FIG. 1e illustrates a view out of a windshield of the vehicle of FIG. 1a of a virtual image of a HUD after the colors of the virtual image have been adjusted for better color contrast according to the present invention, and with the forward-facing environment in the background. In this example, the HUD colors that are presented have been changed from yellow to purple so as to provide a better contrast with the shades of yellow and orange in the background.

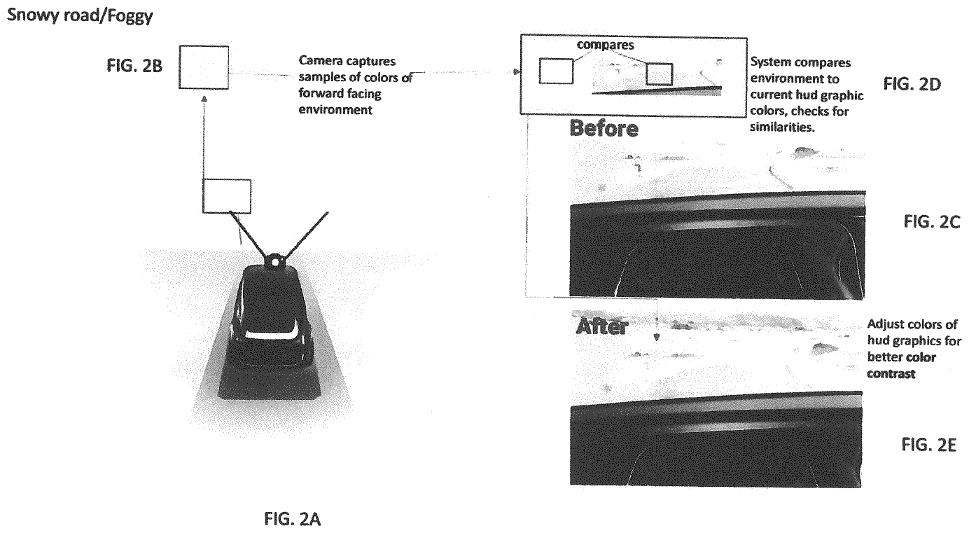

FIG. 2a illustrates another embodiment of a motor vehicle including an environmentally contextual HUD arrangement of the present invention. The HUD arrangement includes a forward-facing camera that captures images of the scene in front of the vehicle that may be in the background of the virtual images provided by the HUD. The camera may be used for other purposes, such as capturing images of other vehicles and pedestrians on the road, for example.

FIG. 2b illustrates a sample of colors of the forward-facing environment of the vehicle of FIG. 2a as captured by a camera of the environmentally contextual HUD arrangement of the vehicle of FIG. 2a. In this example, the sample includes shades of white with a blue or green tint, which may be due to the vehicle driving in snowy or foggy weather or environments.

FIG. 2c illustrates a view out of a windshield of the vehicle of FIG. 2a of a virtual image of a HUD with the forward-facing environment in the background. In this example, the virtual image includes a lot of light blue, and the view through the windshield includes shades of white with a blue or green tint, which may be due to the vehicle driving in snowy or foggy weather or environments.

FIG. 2d illustrates a side by side comparison of the sample of colors of FIG. 2b and the virtual image of FIG. 2c. The HUD arrangement may include an electronic processor which compares the environmental background colors to the current HUD virtual image graphics colors. The processor may check for similarities between the environmental background colors and the current HUD virtual image graphics colors. In this case, the processor may determine, by applying principles of color science and/or by using a lookup table, that the light blue colors in the HUD virtual image graphics colors are very close to the shades of white with green or blue tint in the background. For example, the processor may determine that the colors are too close for the human driver to easily discern the HUD virtual image and see what the HUD is presenting.

FIG. 2e illustrates a view out of a windshield of the vehicle of FIG. 2a of a virtual image of a HUD after the colors of the virtual image have been adjusted for better color contrast according to the present invention, and with the forward-facing environment in the background. In this example, the HUD colors that are presented have been changed from light blue to yellow and orange so as to provide a better contrast with the shades of white with a green or blue tint in the background.

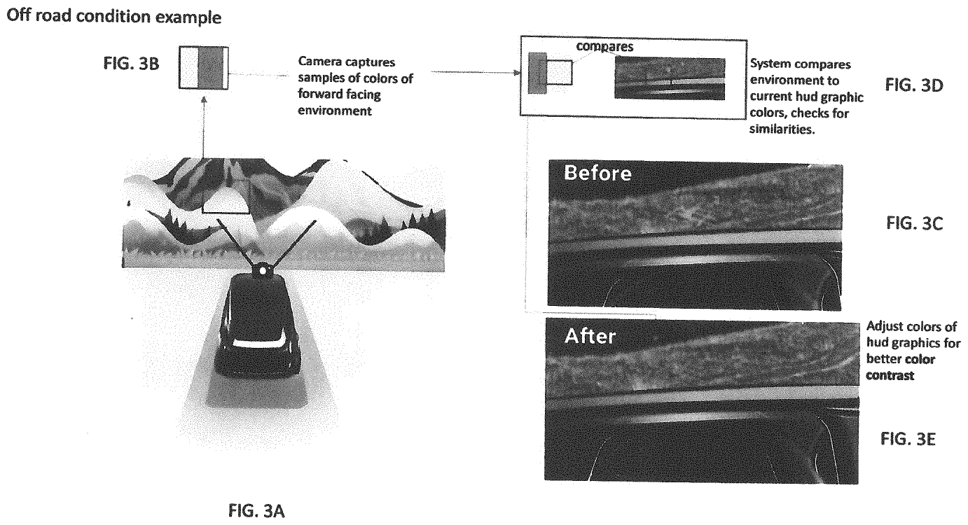

FIG. 3a illustrates yet another embodiment of a motor vehicle including an environmentally contextual HUD arrangement of the present invention. The HUD arrangement includes a forward-facing camera that captures images of the scene in front of the vehicle that may be in the background of the virtual images provided by the HUD. The camera may be used for other purposes, such as capturing images of other vehicles and pedestrians on the road, for example.

FIG. 3b illustrates a sample of colors of the forward-facing environment of the vehicle of FIG. 3a as captured by a camera of the environmentally contextual HUD arrangement of the vehicle of FIG. 3a. In this example, the sample includes shades of green, which may be due to the vehicle driving in an off-road environment in which there are many trees and other green vegetation.

FIG. 3c illustrates a view out of a windshield of the vehicle of FIG. 3a of a virtual image of a HUD with the forward-facing environment in the background. In this example, the virtual image includes a lot of light green, and the view through the windshield includes shades of green, which may be due to the vehicle driving in an off-road environment.

FIG. 3d illustrates a side by side comparison of the sample of colors of FIG. 3b and the virtual image of FIG. 3c. The MUD arrangement may include an electronic processor which compares the environmental background colors to the current HUD virtual image graphics colors. The processor may check for similarities between the environmental background colors and the current HUD virtual image graphics colors. In this case, the processor may determine, by applying principles of color science and/or by using a lookup table, that the light green colors in the HAD virtual image graphics colors are very close to the shades of green in the background. For example, the processor may determine that the colors are too close for the human driver to easily discern the virtual image and see what the HUD is presenting.

FIG. 3e illustrates a view out of a windshield of the vehicle of FIG. 3a of a virtual image of a HUD after the colors of the virtual image have been adjusted for better color contrast according to the present invention, and with the forward-facing environment in the background. In this example, the HUD colors that are presented have been changed from light green to orange so as to provide a better contrast with the shades of green in the background.

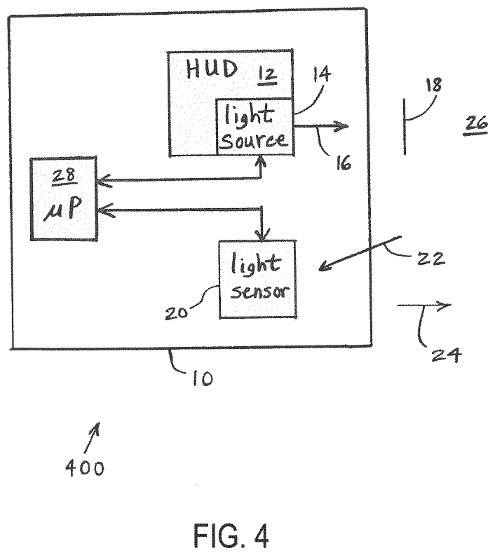

FIG. 4 is a block diagram of one embodiment of a head up display arrangement 400 of the present invention for a motor vehicle 10 with a human driver. A head up display (HUD) 12 includes a light source 14 that emits a light field 16 having a first color such that the light field is visible to the driver as a virtual image 18. A light sensor 20 receives ambient light 22 and detects a second color that is visible to the driver in a forward direction 24 of vehicle 10 in an ambient environment 26 outside of vehicle 10.

An electronic processor 28 is communicatively coupled to both light source 14 and light sensor 20. Processor 28 may change the first color in the light field to a third color. The third color is dependent upon the second color. For example, the third color may have a high degree of contrast vis-a-vis the second color. More particularly, processor 28 may compare the first color to the second color. If the color comparison reveals that a contrast between the first color and the second color is less than a threshold, then processor 28 may change the first color in the light field to a third color. A contrast between the third color and the second color may be greater than the contrast between the first color and the second color.

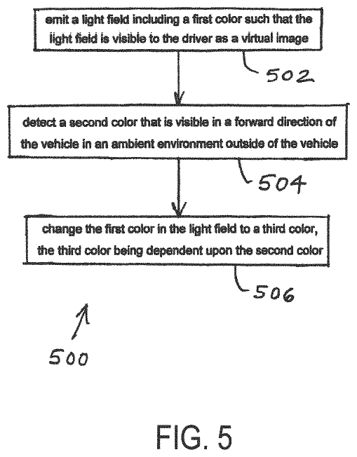

FIG. 5 illustrates one embodiment of a head up display method 500 of the present invention for a motor vehicle having a human driver. In a first step 502, a light field including a first color is emitted such that the light field is visible to the driver as a virtual image. For example, light source 14 may emit a light field that is visible to the driver of vehicle 10 as two orange digits indicating the speed of vehicle 10.

In a next step 504, a second color that is visible in a forward direction of the vehicle is detected in an ambient environment outside of the vehicle. For example, with vehicle 10 driving toward a sunset, light sensor 20 may detect the color yellow in the sky as background for the two orange digits indicating the speed of vehicle 10.

In a final step 506, the first color in the light field is changed to a third color. The third color is dependent upon the second color. For example, processor 28 may determine that there is a low level of contrast between orange and yellow. Accordingly, processor 28 may change the color of the two digits indicating the speed of vehicle 10 to a color having a higher degree of contrast with the yellow background, such as blue, for example.

The invention has been described above as including changing colors of the virtual image, but changes are not limited to color within the scope of the invention. Other augmentations may include flipping the image representation to cut outs, or negatives. In addition to different colors, the HUD may also display different sets of content as well. Using the same or similar methodologies, the HUD system may accommodate surroundings to display contextual information in that setting. For example, if recognizing a lot of snow in the image sensor signals, the HUD may display augmented road lines and augmented lane markers in this environment.

As the industry adds more features to the HUD, including image feeds, it is also possible within the scope of the invention to apply filters to image feeds to augment appearance for better visibility. Such image feeds may be from back up cameras directed in the reverse direction, for example. If a HUD projects characters, symbols and icons that are superimposed over an image feed from a camera directed in a reverse direction, the colors of the characters, symbols and icons may be controlled and modified so as to provide high color contrast between the colors of the characters, symbols and icons and the colors in the image feed from the camera directed in the reverse direction.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle having a human driver, the arrangement comprising:
a light source configured to emit a light field including a first color such that the light field is visible to the driver as a virtual image;
a light sensor configured to detect a second color that is visible to the driver in a forward direction of the vehicle in an ambient environment outside of the vehicle; and
an electronic processor communicatively coupled to both the light source and the light sensor, the processor being configured to change the first color in the light field to a third color, the third color being dependent upon the second color.

2. The head up display arrangement of claim 1 wherein the light source comprises a picture generation unit.

3. The head up display arrangement of claim 1 wherein the light sensor comprises a camera.

4. The head up display arrangement of claim 3 wherein the camera is configured to capture images of pedestrians and other vehicles in front of the vehicle.

5. The head up display arrangement of claim 1 wherein the second color is visible to the driver in a background of the virtual image.

6. The head up display arrangement of claim 1 wherein a contrast between the third color and the second color is greater than a contrast between the first color and the second color.

7. The head up display arrangement of claim 1 further comprising a minor positioned and configured to reflect the light field from the light source to a windshield of the vehicle.

8. A head up display method for a motor vehicle having a human driver, said method comprising:
emitting a light field including a first color such that the light field is visible to the driver as a virtual image;
detecting a second color that is visible in a forward direction of the vehicle in an ambient environment outside of the vehicle; and
changing the first color in the light field to a third color, the third color being dependent upon the second color.

9. The method of claim 8 wherein the light field is emitted by a picture generation unit.

10. The method of claim 8 wherein the second color is detected by a camera.

11. The method of claim 10 wherein the camera captures images of pedestrians and other vehicles in front of the vehicle.

12. The method of claim 8 wherein the second color is visible to the driver in a background of the virtual image.

13. The method of claim 8 wherein a contrast between the third color and the second color is greater than a contrast between the first color and the second color.

14. The method of claim 8 further comprising using a mirror to reflect the light field from the light source to a windshield of the vehicle.

15. A head up display arrangement for a motor vehicle having a human driver, comprising:
a light source configured to emit a light field including a first color such that the light field is reflected off of a windshield of the vehicle and the light field is visible to the human driver as a virtual image;
a light sensor configured to detect a second color that is visible in a background of the virtual image as viewed by the human driver; and
an electronic processor communicatively coupled to both the light source and the light sensor, the processor being configured to:
compare the first color to the second color; and
if the color comparison reveals that a contrast between the first color and the second color is less than a threshold, then change the first color in the light field to a third color, a contrast between the third color and the second color being greater than the contrast between the first color and the second color.

16. The head up display arrangement of claim 15 wherein the light source comprises a picture generation unit.

17. The head up display arrangement of claim 15 wherein the light sensor comprises a camera.

18. The head up display arrangement of claim 17 wherein the camera is configured to capture images of pedestrians and other vehicles in front of the vehicle.

19. The head tip display arrangement of claim 15 further comprising a mirror positioned and configured to reflect the light field from the light source to a windshield of the vehicle.

20. The head up display arrangement of claim 15 wherein the second color is visible to the driver in a forward direction of the vehicle.
